(19) United States
(12) Patent Application Publication
(10) Pub. No.: US 2025/0362533 A1
(43) Pub. Date: Nov. 27, 2025

(54) OPTICAL MODULATOR WITH MESA ARRAYS IN SUBSTRATE

(71) Applicant: Raytheon Company, Tewksbury, MA (US)

(72) Inventors: Guomin Yu, San Diego, CA (US); Ping Piu Kuo, San Diego, CA (US)

(21) Appl. No.: 18/673,133

(22) Filed: May 23, 2024

(51) Int. Cl. G02F 1/035; G02F 1/21

(52) U.S. Cl. CPC G02F 1/035; G02F 1/212

(57) ABSTRACT

An electro-optic device includes a substrate layer, and an optical structure that comprises a thin film layer of electro-optic active material disposed over the substrate layer. The substrate layer comprises a mesa array defining a plurality of air gaps within the substrate layer. A portion of the plurality of air gaps is disposed directly below the optical structure.

### TECHNICAL FIELD

This disclosure relates generally to optical modulators. More specifically, this disclosure relates to an optical modulator with mesa arrays in a substrate.

### BACKGROUND

Electro-optic switching and signal modulation devices that implement logical functions through the flow of photons present significant promise in terms of advancing processor power beyond what is physically possible by implementing processing logic through the manipulation of electron flows through transistor gates. The predicted improvements in processing power from electro-optic switching and signal modulation derive in part from the fact that such devices can often perform switching tasks faster and with less energy. Thin film lithium niobate (“TFLN”) optical modulators leverage a unique property of TFLN in that its refractive index changes in response to an electrical field and are of particular interest for many applications.

### SUMMARY

This disclosure relates to an optical modulator with mesa arrays in a substrate.

In a first embodiment, an electro-optic device includes a substrate layer, and an optical structure that comprises a thin film layer of electro-optic active material disposed over the substrate layer. The substrate layer comprises a mesa array defining a plurality of air gaps within the substrate layer. A portion of the plurality of air gaps is disposed directly below the optical structure.

In a second embodiment, a method of making an electro-optic device includes providing a silicon photonic circuit having a first side and a second side. The silicon photonic circuit includes a first optical structure and a first electrode disposed proximate to the first optical structure. The first optical structure and the first electrode are embedded in a matrix material, and the first optical structure is disposed proximate to the first side. The method also includes providing a thin film layer of lithium niobate on the first side of the silicon photonic circuit and providing a substrate layer contacting the thin film layer of lithium niobate. The substrate layer includes a mesa array defining a plurality of air gaps within the substrate layer, and the first optical structure is mechanically supported by the thin film layer of lithium niobate and the substrate layer.

Other technical features may be readily apparent to one skilled in the art from the following figures, descriptions, and claims.

### BRIEF DESCRIPTION OF THE DRAWINGS

For a more complete understanding of this disclosure, reference is made to the following description, taken in conjunction with the accompanying drawings, in which:

FIGS. 1A-1C illustrate example embodiments of electro-optical devices according to this disclosure;

FIGS. 2A-2J illustrate operations of an example method of making an electro-optical device according to this disclosure; and

FIGS. 3A-3B illustrate an example embodiment of electro-optical devices according to this disclosure.

### DETAILED DESCRIPTION

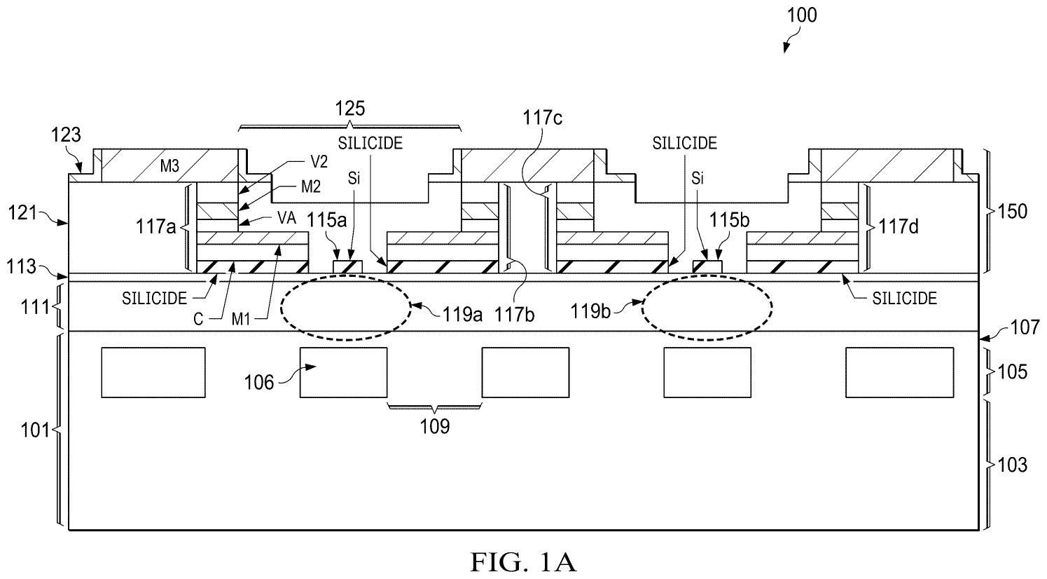

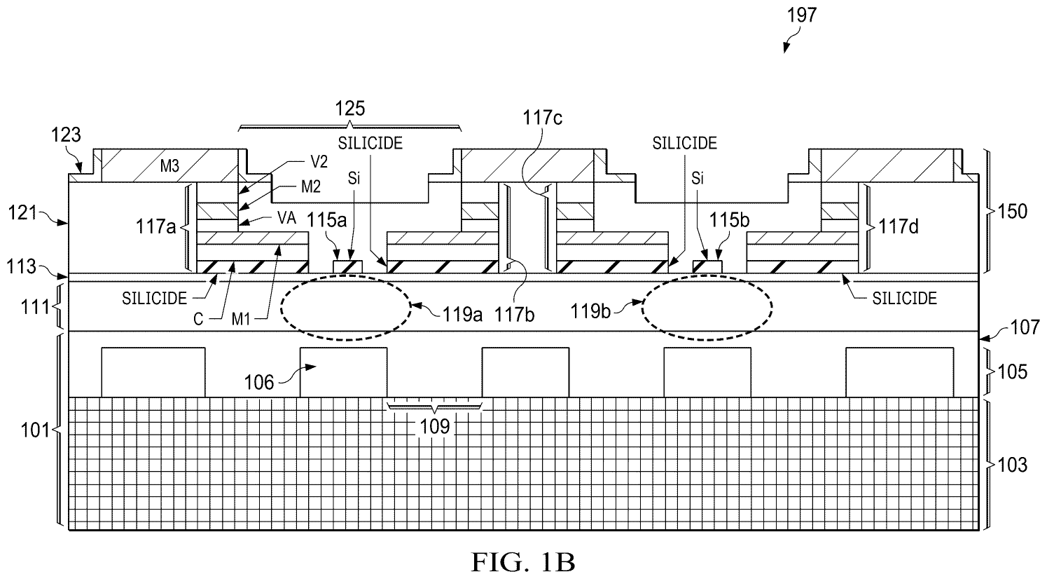

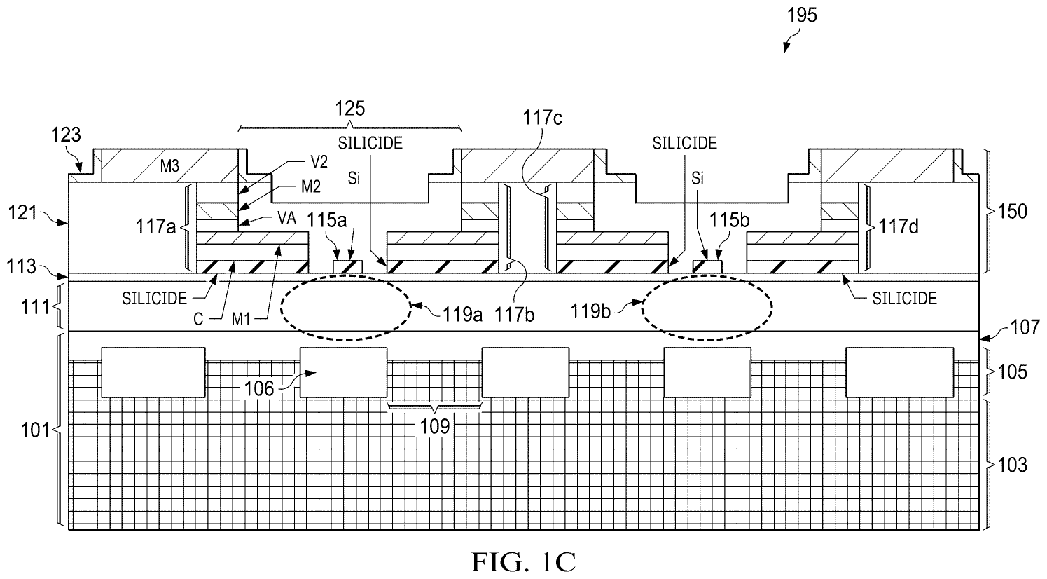

FIGS. 1A through 3B, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

As noted above, electro-optic switching and signal modulation devices that implement logical functions through the flow of photons present significant promise in terms of advancing processor power beyond what is physically possible by implementing processing logic through the manipulation of electron flows through transistor gates. The predicted improvements in processing power from electro-optic switching and signal modulation derive in part from the fact that such devices can often perform switching tasks faster and with less energy. Thin film lithium niobate (“TFLN”) optical modulators leverage a unique property of TFLN in that its refractive index changes in response to an electrical field and are of particular interest for many applications.

In some applications, TFLN optical modulators (such as Mach-Zehnder interferometers) can support the use of periodical capacitive loaded traveling wave electrodes, which provide certain technical benefits over traveling wave electrodes. These technical benefits include enhanced optical-electrical field overlap (such as low Vₚᵢ), with closer electrode spacing. However, the improved Vₚᵢ of periodical capacitive loaded traveling wave electrodes presents technical challenges due to excess capacitive loading in a substrate stack supporting the optical modulators. This includes mismatches between the velocity at which an electromagnetic signal for modulating the refractive index of a lithium niobate layer propagates (referred to as the “RF velocity”) and the velocity at which an optical signal propagates through the lithium niobate layer (referred to as the “optical velocity”). In other words, excess capacitance creates a situation in which a modulating (or control) signal cannot keep pace with the modulated optical signal, thereby resulting in lower bandwidth. Additionally, such excessive capacitance can increase electrical signal losses and create impedance mismatches between optical modulators and devices providing electrical modulation signals to electrodes of the optical modulators.

This disclosure provides various optical modulators with mesa arrays in their substrates, as well as methods for manufacturing such optical modulators. As described below, in these optical modulators, the effective dielectric constant of a substrate can be progressively tuned to optimize the RF velocity while at the same time ensuring sufficient mechanical support for a thin-film lithium niobate layer and optical structures disposed thereupon. In some embodiments, an optical modulator in a mesa array structure is provided in a substrate layer (such as a silicon or silicon oxide substrate layer) to create a sealed airgap directly underneath a waveguide, which is the region of the substrate most directly affecting the effective capacitance of the substrate and therefore the RF velocity. In particular embodiments, the mesa array includes an array of extrusions of a base shape (such as a circle, square, triangle, etc.) extending from the floor of an air gap in a substrate layer to a ceiling of the air gap such that the air gap can be directly underneath a waveguide (thereby minimizing the local dielectric constant around the waveguide), while at the same time providing mechanical support for a thin-film lithium niobate layer and silicon photonic circuitry disposed thereupon.

FIGS. 1A through 1C illustrate example embodiments of electro-optic devices according to this disclosure. For consistency and convenience of cross-reference, elements common to more than one of FIGS. 1A-1C are numbered similarly.

Referring to FIG. 1A, a cross-sectional view of an example electro-optic device 100 according to this disclosure is shown in the figure. Electro-optic device 100 includes a substrate layer 101, which can be a section of a material (such as glass or silicon dioxide) having a lower refractive index than lithium niobate. In some embodiments, substrate layer 101 includes three substructural layers, including a handle or foundation layer 103, a mesa array 105, and a dielectric layer 107.

As shown in FIG. 1A, foundation layer 103 includes the bottom-most layer of electro-optic device 100 (in systems in which silicon photonic circuit 150 is considered to be “on top”) and includes a solid region (such as one not having voids or airgaps within the layer) of one or more materials like glass, silicon with silicon oxide, or silicon oxide having a lower refractive index than lithium niobate. The next layer, mesa array 105, is disposed above foundation layer 103 and includes a sub-region of substrate layer 101 containing one or more air gaps (such as air gap 106) in the material(s) of substrate layer 101 between mesas (such as mesa 109) that collectively define mesa array 105. Foundation layer 103 can provide the floor or otherwise bound the bottom portion of the air gaps within substrate layer 101.

Each mesa of mesa array 105 can be a solid extrusion in one or more materials of a base shape. In some embodiments, to assist in tuning the effective dielectric constant of substrate layer 101, the individual mesas are formed as extrusions of basic shapes, such as circles, ovals, squares, or triangles, to facilitate computer modelling the effect of the air gap between the mesas. The individual mesas of mesa array 105 can be provided in a pattern repeating along two axes, thereby creating a single, connected air gap. In some embodiments, the individual mesas of mesa array 105 can be provided in a pattern that repeats across a single axis, thereby creating a plurality of separate air gaps running along the length of foundation layer 103. Similarly, mesa array 105 can include a pattern extrusions of a plurality of base shapes, such as when not all of the mesas have to have the same width and length dimensions.

Substrate layer 101 may further include a dielectric layer 107 that provides a ceiling for the air gaps and provides continuous mechanical support for the layers above. Dielectric layer 107 is formed from a material having a lower refractive index than lithium niobate and, in some embodiments, can be formed from the same material as at least a portion of the mesas of mesa array 105. While the present disclosure should not be construed as limiting embodiments to any specific dimensional range, in some embodiments, a lithium niobate layer of about 600 nm, an electrode spacing on the order of about 22 μm, circular mesas of about 25 μm, mesa heights of about 1 μm to about 20 μm, and dielectric layer 107 having a thickness of about 0.5 μ may be used. These particular dimensions may allow the RF index to be tuned to within about 98% to 100 of the refractive index, thereby allowing the optical and RF velocities in the system to substantially match. Note that the phrase “substantially match” in this disclosure means matching to within 10%, which can include more specific matches such as with 9%, 8%, . . . , 1%, or even better.

A thin film lithium niobate layer 111 is disposed over top of the dielectric layer 107 of substrate layer 101. In some embodiments, layer 111 can be formed from any electro-optic active material, one or more of whose optical properties (such as optical refractive index, or optical absorption coefficient, or optical gain) may be changed by presenting an electrical field, electrical current or electric charges. Examples of electro-optic active material suitable for layer 111 include, without limitation, lithium niobate, barium titanate, and III-V semiconductor materials. Because dielectric layer 107 provides a ceiling for the air gap(s) between mesas of mesa array 105, thin film lithium niobate layer 111 can be provided as a continuous layer within electro-optic device 100. In other words, both thin film lithium niobate layer 111 and silicon photonic circuit 150 can be mechanically supported across the full area of electro-optic device 100. In practical terms, this makes electro-optic device 100 equivalently rugged and structurally sound as an equivalent but lower-performing device with a solid substrate (due to excess capacitance in the substrate layer).

A silicon photonic circuit 150 can be disposed over top of thin film lithium niobate layer 111. In some embodiments, silicon photonic circuit 150 includes a Mach-Zehnder interferometer, where a light signal is passed through a pair of substantially parallel waveguides overlaying thin film lithium niobate layer 111. As described in greater detail below, one or more electrodes run substantially parallel to the waveguides. By selectively energizing the electrodes, localized electrical fields can be created in the lithium niobate proximate to each of the waveguides, which in turn locally modulates the refractive index of thin film lithium niobate layer 111. By locally and selectively modulating the refractive index within parallel waveguides, the phase of substantially parallel optical signals (such as light) passing through the waveguides can be modulated so that, when the optical signals are combined, the result of the combination can either be constructive (such as when optical signals are in phase) or destructive (such as when optical signals are out of phase). In this way, electro-optic device 100 can operate as a logic gate in which an output is conditioned upon the combined state of two inputs. However, as already noted, silicon photonic circuit 150 need not be a Mach-Zehnder interferometer and can be any type of electro-optic circuit for which excess capacitance in a substrate supporting a thin film lithium niobate presents an obstacle to performance gains. Examples of other silicon photonic circuits according to this disclosure include, without limitation, electro-optic phase modulators and ring modulators. Examples of other silicon photonic circuits which can incorporate substrate 101 include, without limitation, electro-optic phase modulators, electro-absorption modulators (EAM), directly modulated lasers (DML), and electro-absorption modulated lasers (EML).

In this example, silicon photonic circuit 150 includes a bond layer 113 of silicon dioxide, which in some embodiments can be about 0 nm to about 300 nm thick. The bond layer 113 serves to help form optical modes in thin film lithium niobate layer 111. Silicon photonic circuit 150 can further include one or more optical structures, such as first and second waveguides 115a and 115b, which are disposed directly the one or more air gaps created by mesa array 105. In this example, a portion of air gap 106 is disposed directly below first waveguide 115a. First and second waveguides 115a and 115b can include elongated sections of a suitable material, such as silicon or silicon nitride.

Silicon photonic circuit 150 may further include at least one electrode, such as first electrode 117a, second electrode 117b, third electrode 117c, and fourth electrode 117d, disposed proximate to first and second waveguides 115a and 115b. In some embodiments, one or more electrodes 117a-117d include stacked layers of conducting (such as metal), semi-conducting, and insulating materials (shown in the figures as V2, M2, VA, M1, C and a silicide layer) in which RF electrical signals can be passed to selectively create an electric field in regions 119a and 119b for modulating the refractive index of thin film lithium niobate layer 111. First and second waveguides 115a and 115b and electrodes 117a-117d are embedded in a matrix material 121, such as silicon dioxide.

In some embodiments, the uppermost portion of the one or more silicon photonic circuits 150 includes a passivation layer 123, including layer of passivation material (such as oxide), into which one or more gaps (such as gap 125) substantially paralleling the waveguides (such as first waveguide 115a) are formed by etching between M3 electrodes. In some embodiments, the effective capacitance (and by implication the RF velocity) of one or more adjacent electrodes can be further tuned by changing the width and depth of the etched gaps. Also, in some embodiments, silicon photonic circuit 150 can be manufactured separately from substrate layer 101 and thin film lithium niobate layer 111. In other words, substrate layer 101 and thin film lithium niobate layer 111 can be used as an improved support platform for one or more pre-existing silicon photonic circuits.

FIG. 1B illustrates another example embodiment of an electro-optic device 197 according to this disclosure. As shown in the figure, electro-optic device 197 includes a multi-electrode silicon photonic circuit 150 disposed over a thin film lithium niobate layer 111, which is supported by a substrate layer 101. In contrast to some embodiments where dielectric layer 107, mesa array 105, and foundation layer 103 of substrate layer 101 are formed from a single material, substrate layer 101 in this example is formed from a plurality of materials. In this particular example, foundation layer 103 is formed of a first material (such as silicon), while mesa array 105 and dielectric layer 107 are formed from a second material (such as silicon dioxide). Using different materials can provide a variety of technical benefits, such as simplifying manufacturing or allowing further tuning of the effective capacitance of substrate layer 101 without having to retool for a different mesa structure for mesa array 105.

FIG. 1C illustrates another example embodiment of an electro-optic device 195 according to this disclosure. In this example, the concept of using multiple materials to form the constituent sub-layers of substrate layer 101 is extended to using multiple materials within a single sub-layer of substrate layer 101. As shown in FIG. 1C, mesa array 105 can include two or more strata of different materials, which can provide one or more technical benefits such as fine-tuning the effective capacitance of substrate layer 101 without having to retool for a different mesa structure.

While FIGS. 1A-1C illustrate structures including mesa arrays in substrates of Mach-Zehnder interferometers, the present disclosure is not so limited and encompasses other electro-optic devices, including, without limitation, ring modulators, phase modulators, EAMs, DMLs, and EMLs.

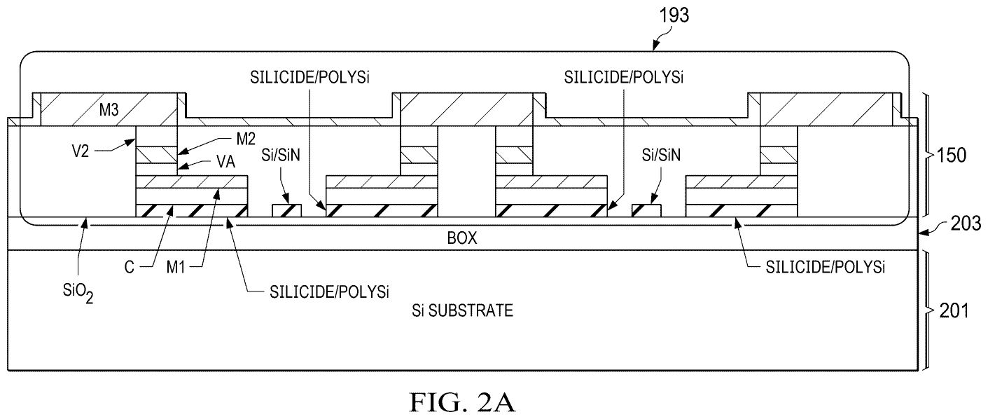

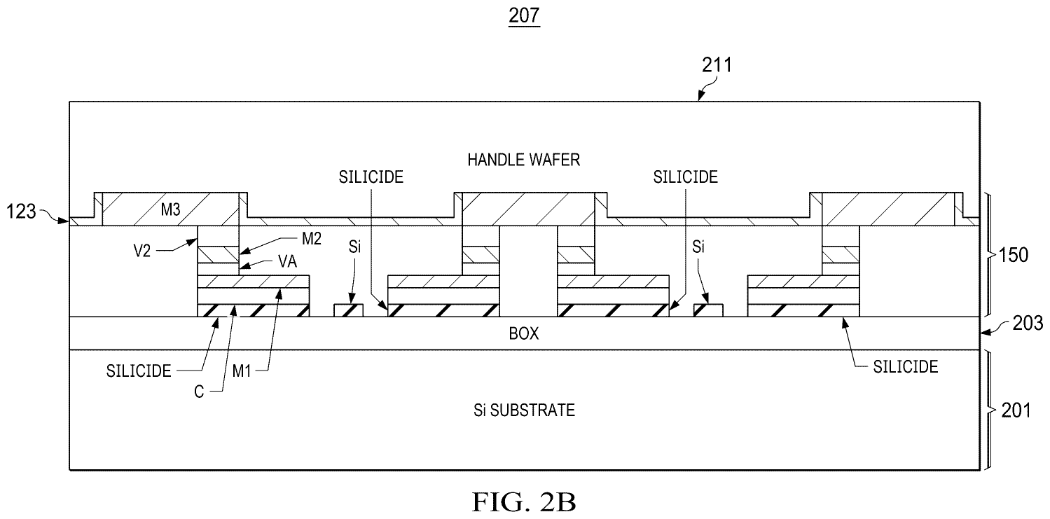

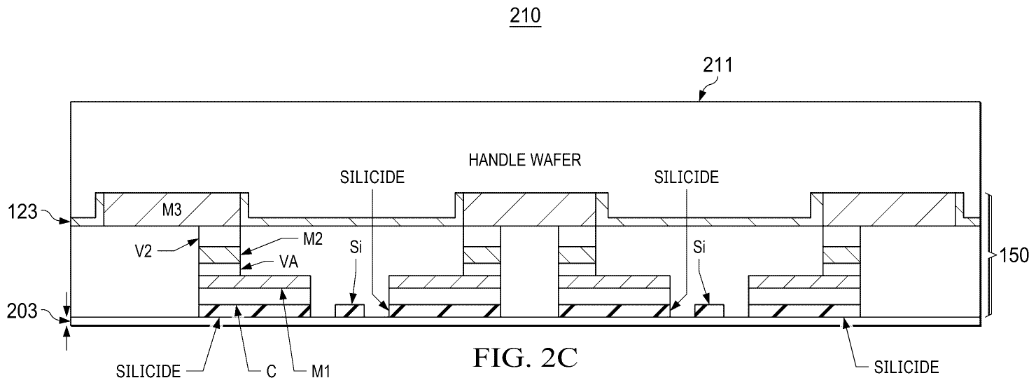

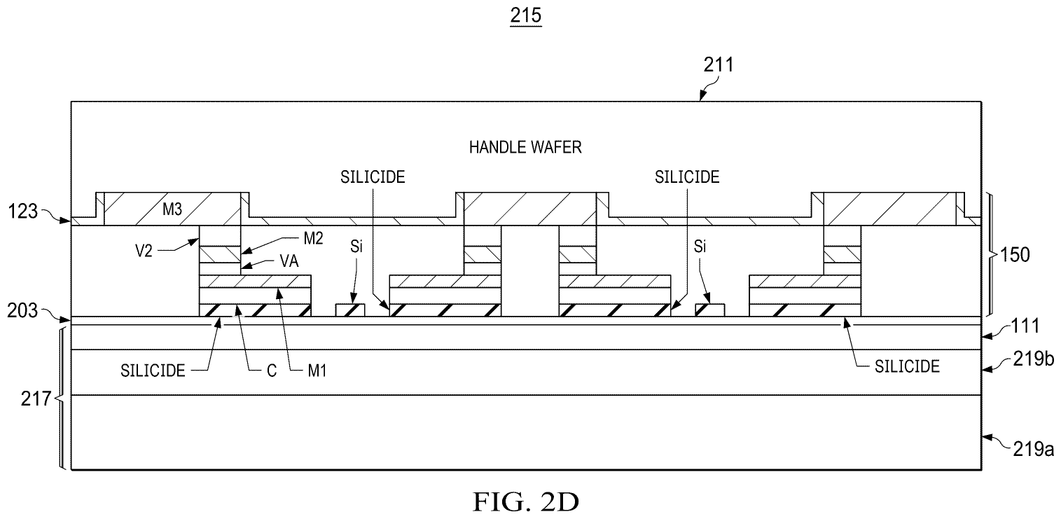

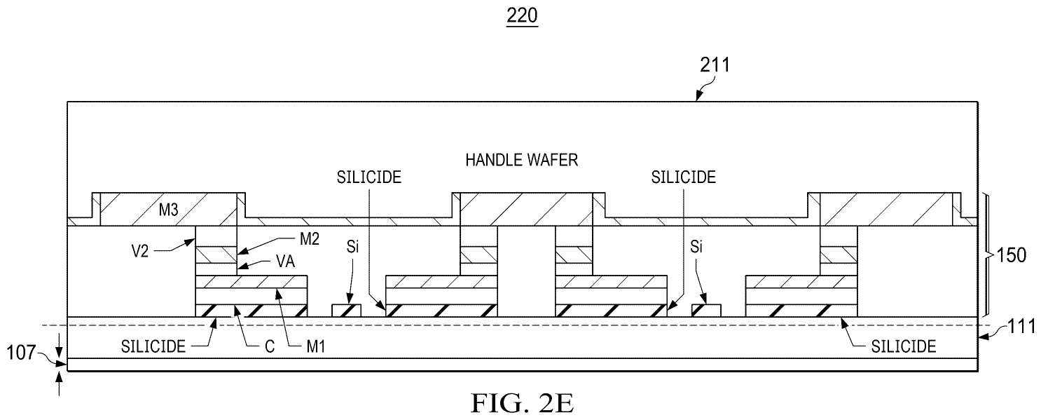

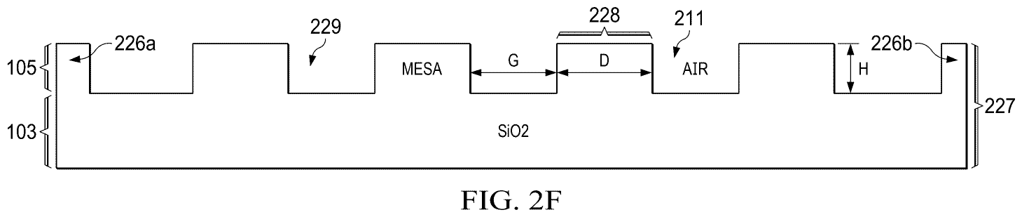

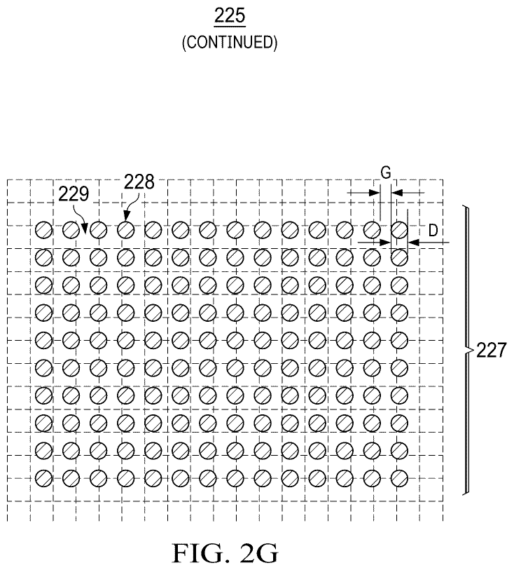

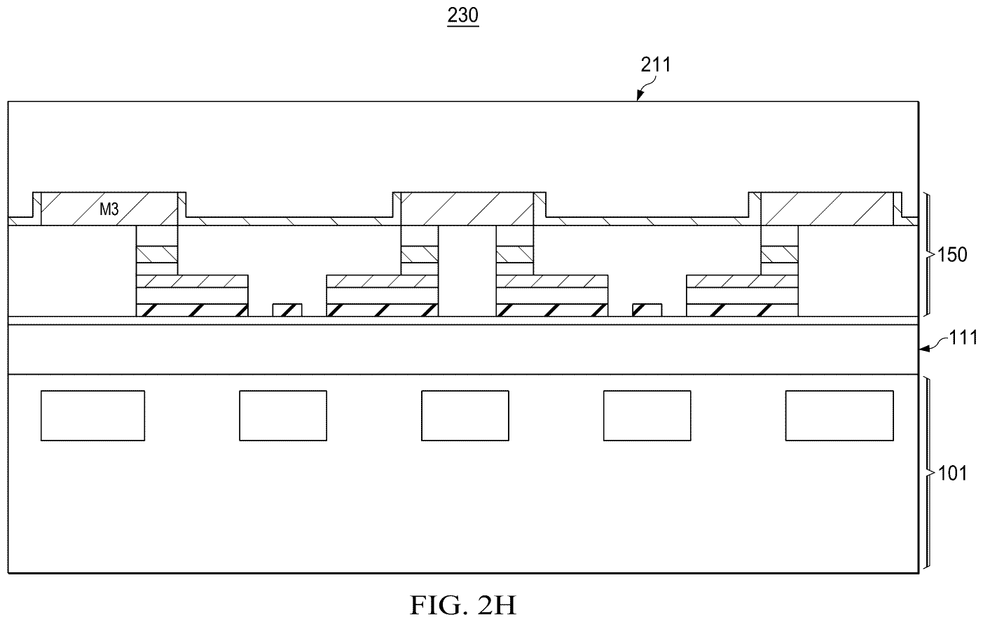

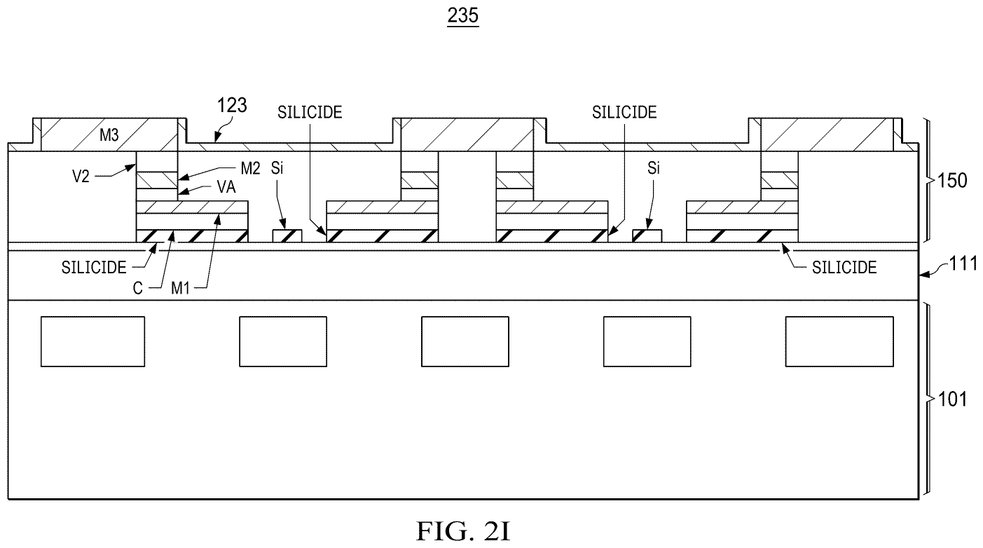

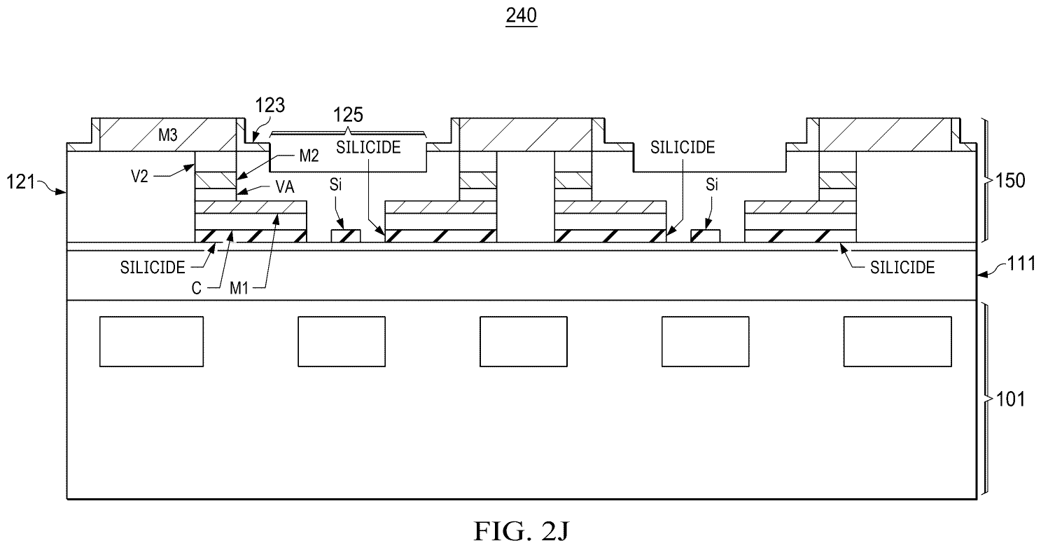

FIGS. 2A-2J illustrate operations of an example method for making electro-optic devices according to this disclosure. For consistency and convenience of cross-reference, elements common to more than one of FIGS. 2A-2J are numbered similarly.

Referring to FIG. 2A, at operation 205, one or more silicon photonic circuits 150 are provided on a layer of buried oxide (BOX) 203 disposed over a manufacturing substrate 201. Manufacturing substrate 201 can be a silicon wafer. In the example shown in FIG. 2A, the one or more silicon photonic circuits 150 include a Mach-Zehnder interferometer of the sort described with reference to FIGS. 1A-1C. However, other embodiments using different silicon photonic devices for which excess capacitance in a substrate layer presents barriers to optimum performance are possible and within the contemplated scope of this disclosure. In some embodiments, silicon photonic circuit 150 is a premanufactured circuit with one or more active regions 193. Also, in some embodiments, silicon photonic circuit 150 is part of a much larger array of such circuits disposed over a single chip.

Turning to FIG. 2B, at operation 207, a handle wafer 211 is affixed to the uppermost surface of silicon photonic circuit 150 such that handle wafer 211 contacts silicon photonic circuit 150, at least in part, along passivation layer 123. As shown in FIG. 2C, at operation 210, manufacturing substrate 201 can be removed. In some embodiments, BOX layer 203 is removed or thinned to an application-appropriate thickness (such as about 0 nm to about 150 nm). Put differently, at operation 210, the “grab point” for manufacturing an electro-optic device incorporating silicon photonic circuit 150 is “flipped” from the underside of silicon photonic circuit 150 to the uppermost portion of silicon photonic circuit 150 so that a thin film lithium niobate layer and a substrate layer with a mesa array can be formed on the underside of silicon photonic circuit 150.

FIG. 2D illustrates operation 215 in which a lithium niobate wafer 217 is bonded to the underside of silicon photonic circuit 150 along a bond layer. In embodiments where some of BOX layer 203 is retained at operation 210, the bond layer connecting lithium niobate wafer 217 and silicon photonic circuit 150 can be the remaining portion of BOX layer 203. Lithium niobate layer can include a base layer 219a of a silicon substrate upon which a silicon oxide layer 219b is disposed, and a lithium niobate layer 111 can be disposed thereupon. As is likely apparent, the example method shown in FIGS. 2A-2J is both additive and substrative in that handling thin films of material may involve the use of carrier substrates. Accordingly, base layer 219a and some portion of silicon oxide layer 219b can be removed after bonding lithium niobate wafer 217 to silicon photonic circuit 150.

FIG. 2E illustrates operation 220 in which the assembly is prepared for creation and construction of a substrate layer with a mesa array underlying silicon photonic circuit 150. Accordingly, at operation 220, base layer 219a of lithium niobate wafer 217 is removed at a minimum. Additionally, the thicknesses of thin film lithium niobate layer 111 and the dielectric layer 107 of what will eventually become substrate layer 101 can be set at operation 220. Depending on the thicknesses of the thin film lithium niobate layer 111 and silicon oxide layer 219b relative to the specified thicknesses of thin film lithium niobate layer 111 and dielectric layer 107 in the finished device, some or all of silicon oxide layer 219b may be removed at operation 220, and some of thin film lithium niobate layer 111 may be removed. For example, where thin film lithium niobate layer 111 needs to be reduced (such as made thinner than as provided in lithium niobate wafer 217), all of silicon oxide layer 219b can be removed to expose thin film lithium niobate layer 111 for reduction, and additional silicon oxide may be applied to thin film lithium niobate layer 111 to form dielectric layer 107. In this way, operation 220 configures thin film lithium niobate layer 111 and dielectric layer 107 such that they provide a region of continuous mechanical support and optical waveguide cladding for electrodes, waveguides, and other constituent structures of silicon photonic circuit 150.

FIGS. 2F and 2G illustrate, through cross-sectional and overhead views, operation 225 of an example method for making an electro-optic device according to this disclosure. At a high level, at operation 225, mesa array 105 and at least part of foundation layer 103 of substrate layer 101 are created. In the illustrative example of FIGS. 2F and 2G, mesa array 105 and foundation layer 103 are formed as a separate mesa assembly 227, which is subsequently bonded to dielectric layer 107 of the device-in-progress shown in FIG. 2D. However, other embodiments are not so limited, and the structures described with reference to FIGS. 2E and 2F can be formed at least partially in situ on dielectric layer 107 (such as by etching or removing material to form a mesa array).

Referring to the illustrative example of FIGS. 2F and 2G, mesa assembly 227 includes a blank (such as flat on top and bottom) wafer of silicon dioxide or alternatively a blank wafer of silicon with a silicon dioxide top film in which mesas of a mesa array can be etched (such as using a dry etch) to form mesa elements (such as mesa element 228) and empty space 229 between the mesa elements. Each mesa element of mesa array 105 may include an extrusion of a base shape (circles in this example, although other shapes being possible) such that the extrusion has a height H and a diameter D and the gaps between mesa elements have a gap width H. The dimensions of G, D and H, as well as the base shape of the mesa elements, can be selected to tune the capacitance for optimal RF velocity. Example values for G, D, and H may include, without limitation, about 35 μm for D, about 25 μm for G, and about 2 μm for H. Of course, other values are possible and within the contemplated scope of this disclosure. Additionally, to ensure accurate registration of the air gaps with mesa assembly with electrode and waveguide structures of silicon photonic circuit 150, mesa assembly 227 can include one or more alignment fiducials (such as alignment fiducials 226a and 226b), which may include pins, bumps, or other reference structures, for aligning mesa assembly 227 with the assembly including silicon photonic circuit 150 and thin film lithium niobate layer 111.

FIG. 2H illustrates operation 230 of the example method, where mesa assembly 227 is bonded to dielectric layer 107 to complete substrate layer 101 so that electro-optical device 100 is mostly complete. At this point, the electro-optical device 100 primarily needs to be detached from handle wafer 211 so that the gaps (such as gap 125) of passivation layer 123 can be formed. FIG. 2I illustrates operation 235 of the example method, where handle wafer 211 is separated from electro-optical device 100, leaving (in embodiments having a passivation layer) passivation layer 123 exposed as the uppermost layer of electro-optical device 100. FIG. 2J illustrates operation 240 of the example method in which passivation layer 123 is etched to form gap 125. As with the air gaps provided in substrate layer 101, the width and depth of gap 125 can be selected to tune the effective capacitance of the system and the RF velocity. Additionally, as shown in FIG. 2H, gap 125 can be cut through passivation layer 123, extending into matrix material 121.

While the examples provided by FIGS. 2A through 2J are described with reference to specific materials and dimensions, these are for illustration and explanation only. This disclosure is not limited to any specific manufacturing techniques for optical modulators or other optical devices.

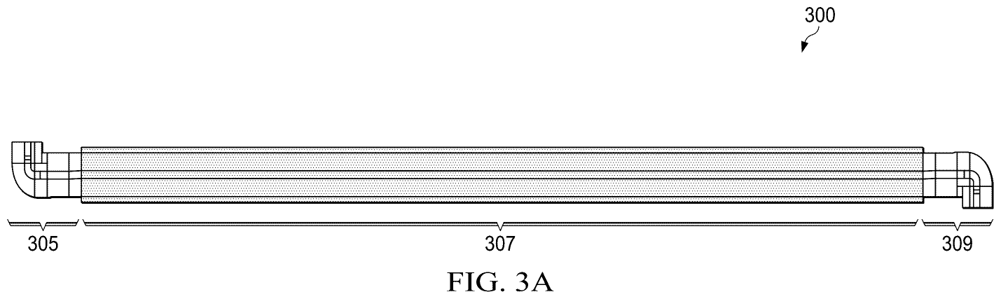

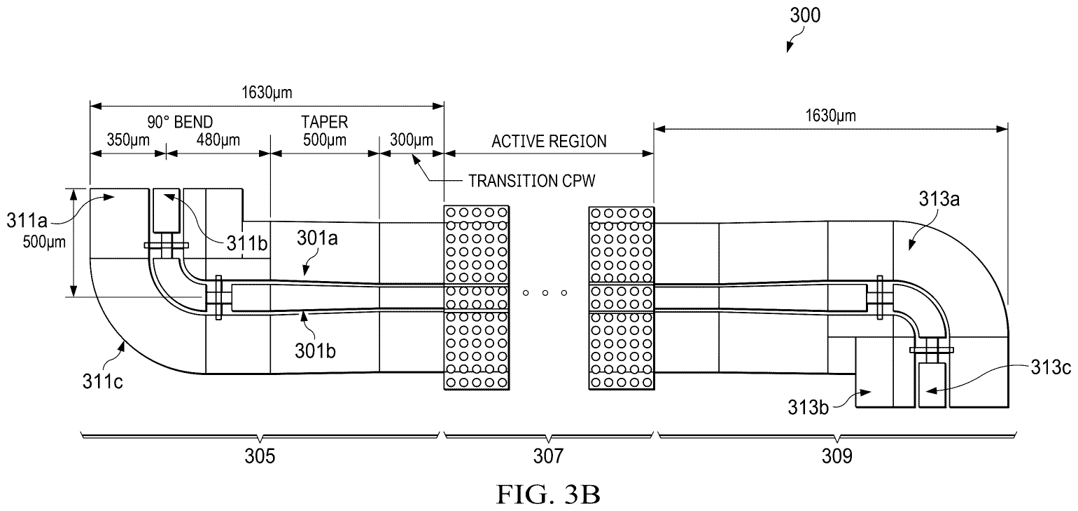

FIGS. 3A and 3B illustrate an example electro-optical apparatus 300 according to certain embodiments of this disclosure. The example apparatus 300 is provided with an example set of dimensions according to some embodiments, although the present disclosure should not be construed as being limited thereto. For consistency and convenience of cross-reference, elements common to more both of FIGS. 3A and 3B are numbered similarly.

As shown here, apparatus 300 includes an interferometer including a lead coplanar waveguide (CPW) 305, an active region 307, and a terminal CPW 309. Lead CPW 305 includes a taper comprising a portion of first electro-optic device 301aa portion of second electro-optic device 301b (such as electro-optic device 100 in FIG. 1), connecting to a first curved region of conductive pads (such as conductive pads 311a, 311b and 311c), and the active region 307, whose dimensions may differ from those of the conductive pads of the first curved region, through which electrical potential can be selectively applied to propagate RF electrical waves along the electrodes of first and second electro-optic devices 301a and 301b.

Apparatus 300 also includes terminal CPW 309 that, like lead CPW 305, also contains a portion of first electro-optic device 301a and second electro-optic device 301b, which are adjacent to a second curved region of conductive pads (such as conductive pads 313a, 313b, and 313c). While not shown in FIGS. 3A and 3B, apparatus 300 can include additional components for generating and sensing photonic signals.

Apparatus 300 further includes an active region 307 in which first electro-optic device 301a and second electro-optic device 301b run substantially in parallel over a substantially equal length of a substrate (such as substrate layer 101) containing a mesa array (such as mesa array 105) mechanically supporting a thin film lithium niobate layer (such as lithium niobate layer 111). In this example, first and second electro-optic devices 301a and 301b are disposed squarely above the gaps between the circular mesa elements. In this way, the local capacitance of the substrate layer supporting the structures shown in FIGS. 3A-3B can be efficaciously tuned to optimize RF velocity without sacrificing continuous mechanical support and optical loss by the substrate for first electro-optic device 301a and second electro-optic device 301b.

While the examples provided by FIGS. 2A through 2J are described with reference to specific materials and dimensions, these are for illustration and explanation only. This disclosure is not limited to any specific manufacturing techniques for optical modulators or other optical devices.

It may be advantageous to set forth definitions of certain words and phrases used throughout this patent document. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. An electro-optic device comprising:
a substrate layer;
an optical structure that comprises a thin film layer of electro-optic active material disposed over the substrate layer;
wherein the substrate layer comprises a mesa array defining a plurality of air gaps within the substrate layer; and
wherein a portion of the plurality of air gaps is disposed directly below the optical structure.

2. The electro-optic device of claim 1, wherein the electro-optic active material is one or more of lithium niobate, barium titanate, a ferroelectric material other than lithium niobate or barium titanate, or a III-V semiconductor material, or
wherein the optical structure is at least a portion of a Mach-Zehnder interferometer, an optical phase modulator, a ring modulator, an electro-absorption modulator (EAM), a directly modulated laser (DML), or an electro-absorption modulated laser (EML).

3. The electro-optic device of claim 1, wherein the thin film layer of electro-optic active material comprises a thin film layer of lithium niobate; and
a first silicon photonic circuit disposed over the thin film layer of lithium niobate, the first silicon photonic circuit comprising:
a first optical structure mechanically supported by the thin film layer of lithium niobate and the substrate layer; and
a first electrode disposed proximate to the first optical structure;
wherein the substrate layer comprises a mesa array defining a plurality of air gaps within the substrate layer; and
wherein a portion of the plurality of air gaps is disposed directly below the first optical structure.

4. The electro-optic device of claim 1, wherein the substrate layer comprises one or more layers of material having a refractive index lower than lithium niobate.

5. The electro-optic device of claim 4, wherein the substrate layer comprises a first layer of a first material and a second layer of a second material.

6. The electro-optic device of claim 1, wherein mesas of the mesa array comprise circular mesas.

7. The electro-optic device of claim 3, wherein:
the first electrode is associated with a radio frequency (RF) velocity at which an electrical wave propagates along the first electrode;
the first optical structure is associated with an optical velocity at which light travels along the first optical structure; and
one or more dimensions of mesas of the mesa array are tuned such that the RF velocity substantially matches the optical velocity.

8. The electro-optic device of claim 3, wherein:
the first silicon photonic circuit further comprises a passivation layer as an uppermost layer, the passivation layer comprising a gap paralleling the optical structure, the gap having an etch width and an etch depth;
the first electrode is associated with a radio frequency (RF) velocity at which an electrical wave propagates along the first electrode;
the first optical structure is associated with an optical velocity at which light travels along the first optical structure; and
the etch width and the etch depth are tuned such that the RF velocity substantially matches the optical velocity.

9. The electro-optic device of claim 1, wherein the substrate layer comprises a layer of silicon dioxide.

10. The electro-optic device of claim 3, wherein the first optical structure comprises at least one of a silicon waveguide or a silicon nitride waveguide disposed over the thin film layer of lithium niobate.

11. The electro-optic device of claim 3, further comprising:
a second optical structure mechanically supported by the thin film layer of lithium niobate and the substrate layer; and
a second electrode disposed proximate to the second optical structure,
wherein a second portion of the plurality of air gaps is disposed directly below the second optical structure.

12. A method of making an electro-optic device, the method comprising:
providing a silicon photonic circuit having a first side and a second side, the silicon photonic circuit comprising:
a first optical structure; and
a first electrode disposed proximate to the first optical structure, the first optical structure and the first electrode embedded in a matrix material, the first optical structure disposed proximate to the first side;
providing a thin film layer of lithium niobate on the first side of the silicon photonic circuit; and
providing a substrate layer contacting the thin film layer of lithium niobate;
wherein the substrate layer comprises a mesa array defining a plurality of air gaps within the substrate layer; and
wherein the first optical structure is mechanically supported by the thin film layer of lithium niobate and the substrate layer.

13. The method of claim 12, wherein a portion of a first air gap of the plurality of air gaps is disposed directly below the first optical structure.

14. The method of claim 12, wherein providing the substrate layer contacting the thin film layer of lithium niobate comprises:
forming a dielectric layer, wherein the dielectric layer contacts the thin film layer of lithium niobate; and
forming a mesa assembly, the mesa assembly comprising a foundation layer supporting the mesa array, the mesa array comprising a plurality of mesas, one or mesas of the plurality of mesas comprising extrusions of a base shape; and
affixing the mesa assembly to the dielectric layer.

15. The method of claim 14, wherein the base shape is circular.

16. The method of claim 14, further comprising:
tuning one or more of a height of the plurality of mesas, a width of the plurality of mesas, or a spacing of the plurality of mesas such that a radio frequency (RF) velocity at which an electrical wave propagates along the first electrode substantially matches an optical velocity at which light travels along the first optical structure.

17. The method of claim 12, further comprising:
providing a passivation layer on a second side of the silicon photonic circuit, the passivation layer comprising a gap paralleling the first optical structure, the gap having an etch width and an etch depth;
wherein the first electrode is associated with a radio frequency (RF) velocity at which an electrical wave propagates along the first electrode;
wherein the first optical structure is associated with an optical velocity at which light travels along the first optical structure; and
wherein the etch width and etch depth are tuned such that the RF velocity substantially matches the optical velocity.

18. The method of claim 12, wherein the silicon photonic circuit further comprises:
a second optical structure mechanically supported by the thin film layer of lithium niobate and the substrate layer; and
a second electrode disposed proximate to the second optical structure,
wherein the second optical structure and the second electrode are embedded in the matrix material, and wherein the second optical structure is disposed proximate to the first side.

19. The method of claim 18, wherein the silicon photonic circuit comprises at least one of a Mach-Zehnder interferometer, a phase modulator, or a ring modulator, or
wherein the substrate layer comprises at least two different materials.

20. The method of claim 19, wherein:
the substrate layer comprises a foundation layer; and
the foundation layer and the mesa array comprise two different materials.
